(19) United States
(12) Patent Application Publication
(10) Pub. No.: US 2021/0101155 A1
(43) Pub. Date: Apr. 8, 2021

(54) MEAT GRINDER

(71) Applicant: George Astwood, Miami, FL (US)

(72) Inventor: George Astwood, Miami, FL (US)

(21) Appl. No.: 16/591,385

(22) Filed: Oct. 2, 2019

(51) Int. Cl. B02C 18/38; A47J 43/08; A22C 9/00; B02C 18/30

(52) U.S. Cl. CPC B02C 18/38; A47J 43/08; B02C 18/305; B02C 18/301; A22C 9/008

(57) ABSTRACT

A grinder for grinding or processing food is presented. The grinder has a top for inputting food into the grinder. The grinder has an inner cavity for receiving the inputted food. The inner cavity has a first clip and a second clip for coupling to a hole plate. The hole plate is for grinding or processing the inputted food. The hole plate has a first end, a second end, a first cap, a second cap, a first connecting peg and a second connecting peg. The first cap is coupled to the first end and the first cap is coupled to the first connecting peg. The first connecting peg is removably coupled to the first clip. The second cap is coupled to the second end and the second cap is coupled to the second connecting peg. The second connecting peg is removably coupled to the second clip. The grinder has a motor that is communicatively coupled to a power source. The motor rotating the hole plate to grind or process the food. The grinder may also have one or more lamps to light the work area, further the lamps are preferably LED lamps.

### FIELD OF THE INVENTION

This invention relates to grinders. More particularly, it relates to meat grinders.

### BACKGROUND

A meat grinder, is a kitchen appliance for fine chopping (‘mincing’) and/or mixing of raw or cooked meat, fish, vegetables or similar food. It replaces took like the mincing knife, for example, which is also used to produce minced meat, filling, etc.

The producer puts the minced food into a funnel, which is placed on the top of the grinder. From there the material goes on a horizontal screw conveyor. This screw conveyor, which can be powered by a hand wheel or an electric motor, squashes and partially mixes the food. At the end of the screw conveyor there is a knife installed directly in front of the fixed hole plate. At this opening the minced meat comes out of the machine. The fineness of the meat depends on the size of the holes of the plate.

By changing the hole plate, it is also possible to produce breadcrumbs or fill sausage casing. After the drop from the retainer, it is possible to change the hole plate. By removing the fixing screw, the grinder can be disassembled completely for cleaning. Besides the domestic manually or motor operated grinders, there are also grinders for butchery (table- or shop-grinders for example) and for the food industry. Some large machines are able to produce several tons per hour.

Meat grinders can be difficult and time consuming to change out the hole plate. There is therefore a need for a meat grinder or food processor in which the hole plates are easily interchangeable when a desire to change the hole plate is determined.

### BRIEF DESCRIPTION OF THE DRAWINGS

FIG. 1A is an illustration of an exemplary grinder.

FIG. 1B are illustrated views of hole plates.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

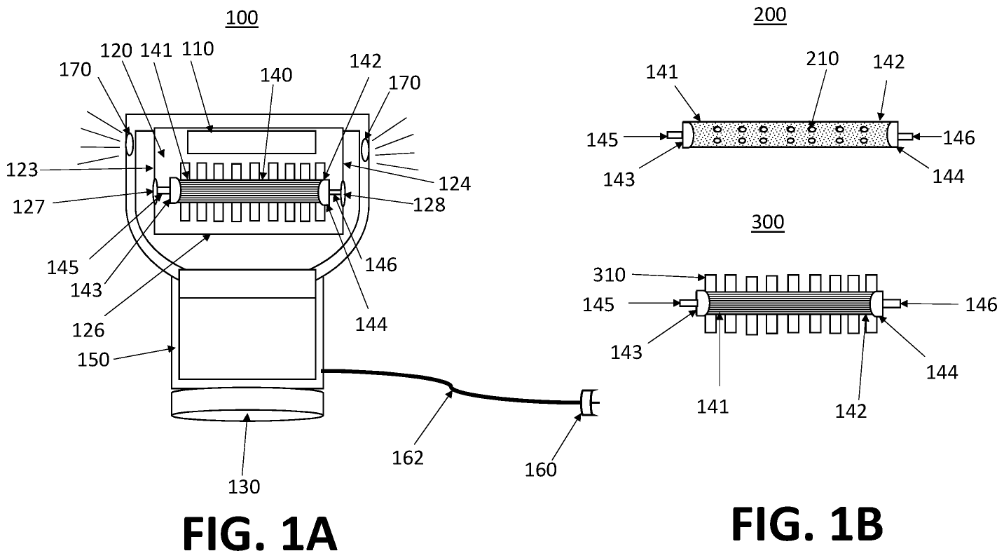

Referring to FIG. 1A, an illustration of an exemplary grinder 100 is presented. The grinder 100 is useful to reduce the time to switch in and out a hole plate by using quick release tabs. The grinder 100 is useful as it can be converted to a food processor by switching to a food processor hole plate. The grinder 100 is preferably metal such as steel, aluminum, etc., but may be plastic, PVC, etc.

The grinder 100 is preferably substantially square in shape, but may be any shape such as trapezoidal, rectangular, etc. The grinder 100 has a height preferably between four and twenty-four (4-24) inches, but may be any other height which is desired.

The grinder 100 has a length preferably in the range of eight and eighteen (8-18) inches, but may be any other length as desired. The grinder 100 has a width of preferably between one-half and two and one-half (0.5-2.5) inches, but may be any other width desired.

The grinder 100 has a top 110, an inner cavity 120, an output 130, a hole plate 140, a motor 150 and a power source connector 160. The top 110 is useful for receiving food desired to be ground or processed by the grinder 100. The food is preferably meat such as beef, chicken, pork, etc. but may be other foods such as vegetables, fruit, etc.

The inner cavity 120 of the grinder 110 is accessible by the top 110. The inner cavity 120 of the grinder has a holding area 122, two sides 123, 124 and a bottom 126. The two sides 123, 124 have a clip 127, 128. The clip 127, 128 receives a connecting post to hold a hole plate.

The hole plate 140 is a plate which determines the grinding level of the food or it may be a food processing device. The hole plate 140 is useful for grinding or processing food to the extent desired by a user. The hole plate 140 has a first end 141, a second end 142, a first cap 143, a second cap 144, a first connecting peg 145 and a second connecting peg 146.

The first cap 143 is securely coupled to the first end 141 of the hole plate 140. The first cap 143 is preferably made of a metal material but may be made of other materials such as plastic, PVC, etc. The first cap is securely coupled to the first connecting peg 145. The first connecting peg 145 is removably coupled to the clip 127 of a first of the two sides 123.

The second cap 144 is securely coupled to the second end 142 of the hole plate 140. The second cap 144 is preferably made of a metal material but may be made of other materials such as plastic, PVC, etc. The second cap 144 is securely coupled to the second connecting peg 146. The second connecting peg 146 is removably coupled to the clip 128 of a second of the two sides 124.

FIG. 1B illustrates two of the types of hole plates 140. A first hole plates 140 is a food processor hole plate 200. The food processor hole plate 200 has a series of holes 210. The food is processed by rotating the food processor hole plate 200 coupled to the clips 127, 128 of the inner cavity 120.

A second hole plate 140 is a grinding hole plate 300. The grinding hole plate 300 has a series of blades 310. The food is processed by rotating the grinding hole plate 300 coupled to the clips 127, 128 of the inner cavity 120.

The food is ground or processed by placing the food through the top 110 of the grinder 100. The food enters the inner cavity 120 and is ground or processed by rotating the hole plate 140 by the motor 150 and outputting the ground or processed food the output 130 of the grinder 100.

The motor 150 has a power source. The power source is preferably ac/dc, but may be solar, battery, etc. The motor 150 of the grinder 100 is coupled to the power source by a power source connector 160. The power source connector 160 is coupled to the motor 150 by a power connector wire 162.

Optionally and or additionally, the grinder 100 may have one or more lamps 170. The one or more lamps 170 are preferably LED lamps but may be other type of lamps such as CFL, fluorescent, penlight, etc. The one or more lamps 170 are useful for providing light to a darkened work area.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A grinder for grinding or processing food, the grinder comprising:
a top, the top for inputting food into the grinder;
an inner cavity, the inner cavity for receiving the inputted food, the inner cavity having a first clip and a second clip, the clips for coupling to a hole plate;
the hole plate, the hole plate being for grinding or processing the inputted food, wherein the hole plate having a first end, a second end, a first cap, a second cap, a first connecting peg and a second connecting peg;
the first cap being coupled to the first end and the first cap coupled to the first connecting peg; wherein the first connecting peg being removably coupled to the first clip;
the second cap being coupled to the second end and the second cap coupled to the second connecting peg; wherein the second connecting peg being removably coupled to the second clip; and
a motor, the motor communicatively coupled to a power source, wherein the motor rotating the hole plate to grind or process the food.

2. The grinder of claim 1, further comprising:
one or more lamps, the lamps being for providing light to the grinder.

3. The grinder of claim 2, wherein the one or more lamps being LED lamps.

4. The grinder of claim 1, wherein the hole plate being a grinding hole plate.

5. The grinder of claim 4, wherein the hole plate having blades.

6. The grinder of claim 1, wherein the hole plate being a food processing hole plate.

7. The grinder of claim 6, wherein the hole plate having holes.

8. The grinder of claim 1, wherein the grinder having a length of between eight and eighteen (8-18) inches.

9. The grinder of claim 1, wherein the grinder having a height of between four and twenty-four (4-24) inches.

10. The grinder of claim 1, wherein the grinder having a width of between one-half and two and one-half (0.5-2.5) inches.

11. The grinder of claim 1, wherein the grinder being made of a metal material.

12. The grinder of claim 11, wherein the metal material being steel.
